(19) United States
(12) Patent Application Publication
(10) Pub. No.: US 2009/0002545 A1
(43) Pub. Date: Jan. 1, 2009

(54) Method and system for color management in digital imaging

(75) Inventors: Tomi Heinonen, Tampere (FI); Ossi Kalevo, Toijala (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/824,598

(22) Filed: Jun. 29, 2007

(51) Int. Cl. H04N 5/232

(52) U.S. Cl. 348/370

(57) ABSTRACT

A color management system has an illuminating source identification algorithm to identify the ambience at which a picture is taken. One or more illumination sensors, along with a plurality of narrow-band filters are used to measure the spectral distribution of the illuminating light so that the illuminating source or sources can be identified. Based on the identified ambience, the color contents of the image data can be corrected. At the image visualization stage, the image data can be further corrected based on the color characteristics of the display device. Part of the color management system can be integrated into an image device, for example. Thus, an illumination sensor can be provided in a camera to spectral measurement purposes. A user interface can be used to allow a user to identify the picture-taking ambience.

### FIELD OF THE INVENTION

The present invention relates generally to color management and sensor design in digital imaging and, more particularly, to spectral measurement on the illumination for color correction on the image data.

### BACKGROUND OF THE INVENTION

Images captured by a camera may be displayed on a number of different devices. The display devices may be liquid-crystal display (LCD) devices, organic light-emitting diode (OLED), plasma display devices, and cathode-ray tube (CRT) devices, for example. Likewise, an image display may be use to display images captured from different digital cameras. These image capturing and visualization devices may have different color properties, such as color space (gamut), non-linearity relation between image data and pixel brightness, and so forth. Thus, an image may appear visually different when displayed on different display devices. In some imaging systems, a captured image (captured in camera's own RGB color space) is processed to another color space (e.g., sRGB) and then transformed into a different color space (e.g., CMYK, or display's own RGB color space) for display. Color management is concerned with the controlled conversion from one color space to another and the controlled conversion between the colors of different visualization devices. These visualization devices also include color printers and other image reproduction devices. The primary goal of color management is to obtain a good match across color image visualization devices so that an image reproduced on one device could appear closely to the same image displayed on another device.

Due to camera sensor design, the sensor elements may have different sensitivity to different colors and they may also be sensitive to particular background illumination spectra. Also, objects usually reflect differently within different background illumination and so the sensor will capture different amounts of photons from the objects. That is why indoor images appear differently from outdoor images. Furthermore, the appearance of indoor images depends on the indoor illumination sources which may include candles, incandescent bulbs, fluorescent tubes and flash. Theses light sources have different spectral characteristics, affecting the captured images due to the color sensitivity of the image sensor and the spectral reflectance of objects. The ambient light condition renders it difficult to carry out the so-called white balance adjustment. This problem becomes more complex in a mixed light condition when two or more types of light sources are used at the same time.

It is advantageous and desirable to provide a color management method and system for improving the image appearance.

### SUMMARY OF THE INVENTION

The present invention provides a method and a system for color management. The color management system can be integrated into an imaging device, such as a camera or a mobile phone, for adjusting the color contents of an image taken by the image device. Part of the color management system can be associated with an image display device for further adjusting the image data based on the color characteristics of the image display device.

Thus, the first aspect of the present invention is a method for color management. The method comprises:

measuring spectral distribution of illuminating light of a scene substantially at a time of taking a picture of the scene for providing measurement data indicative of the spectral distribution;

identifying one or more sources of the illuminating light based on the measurement data; and

adjusting the color contents in the image data based on the identified one or more sources.

The method further comprises establishing a white point for each of said one or more sources, wherein said adjusting is also based on the white point for said one or more sources.

The second aspect of the present invention is a color management system, which comprises:

a color sensing module having one or more sensors an a plurality of narrow-band color filters for measuring spectral distribution of illuminating light of a scene substantially at the time of taking a picture of the scene for providing measurement data indicative of the spectral distribution; and

a processor, for identifying one or more sources of the illuminating light based on the measurement data, wherein the processor is also adapted for adjusting the color contents in the image data based on the identified one or more sources. A source spectral data bank comprising spectral data of a plurality of illuminating sources provided to the processor so as to allow the processor to identify said one or more sources of the illuminating light also based on the source spectral data bank.

As the image data is displayed on an image display device, the color contents of the image data can also be adjusted based on the color characteristics of the image display device. To that end, the color management system further comprises a sensor element for measuring the color characteristics of image display device.

The third aspect of the present invention is an imaging device, which comprises:

an imaging sensor for picture taking under illuminating light;

a source sensor, adapted for measuring spectral distribution of the illuminating light substantially at a time of taking a picture for providing measurement data indicative of the spectral distribution; and

a processor, for identifying one or more sources of the illuminating light based on the measurement data and for adjusting the color contents of the picture based on the identified source or sources of the illuminating light.

The imaging device further comprises an optical unit for receiving part of the illuminating light and for focusing part of the received illuminating light on the imaging sensor for picture taking, and a light directing element, disposed in relationship to the optical unit, for directing a portion of the received illuminating light to the source sensor.

The light directing element may comprise one or more reflecting surfaces for directing the portion of the received illuminating light to the source sensor. The light directing element may comprise one or more light conduits for directing the portion of the received illuminating light from said one or more reflecting surfaces to the source sensor through the narrow-band color filters, and one or more light diffusing elements disposed between the light direction element and the color filters.

The light directing element may comprise one or more lenses for directing the portion of the received illuminating light to the source sensor.

The imaging device may have a user interface for allowing a user to identify ambience at the time of picture taking, wherein the identified ambience may include the time of picture taking, the place of picture taking or the light source or sources. The fourth aspect of the present invention is an electronic device, such as a mobile terminal, a PDA, a communication device or the like. The electronic device includes an image device with part of the color management system, according to the present invention.

The present invention will become apparent upon reading the description taken in conjunction with FIGS. 1 to 11.

### BRIEF DESCRIPTION OF THE DRAWINGS

FIG. 1 is a block diagram illustrating the method and apparatus for correcting the color image data based on the ambient light condition at the time of image capturing.

FIG. 2 is a block diagram showing how a look-up table is selected according to the illuminating source.

FIG. 3 is a block diagram illustrating the method and apparatus for correcting the color image data based on the illumination condition at the time of image display.

FIG. 4 is a block diagram showing how a look-up table is selected according to the display illumination.

FIG. 5 is a schematic representation of an imaging device wherein part of the illuminating light collected by the imaging lens is used for determining the illuminating source.

FIG. 6a is a schematic representation of an imaging device wherein part of the illuminating light collected by the imaging lens is channeled through a light conduit to the illumination sensor located on the image plane.

FIG. 6b is a schematic representation of an imaging system wherein part of the illuminating light collected by the imaging lens is channeled through a light conduit to the illumination sensor located off the image plane.

FIG. 6c is a schematic representation of an imaging system wherein part of the illuminating light collected by the imaging lens is directly sensed by the illumination sensor.

FIG. 7a is a schematic representation of an imaging device wherein part of the illuminating light collected by a separate lens is channeled through a light conduit to the illumination sensors.

FIG. 7b is a schematic representation of an imaging device wherein part of the illuminating light collected by a separate lens is directly sensed by the illumination sensors.

FIG. 8a is an example showing the arrangement of an illumination sensor and an image sensor on the same semiconductor chip.

FIG. 8b is another example showing the arrangement of an illumination sensor and an image sensor on the same semiconductor chip.

FIG. 8c is an example showing the arrangement of a plurality of illumination sensors around the imaging sensor.

FIG. 8d is an example showing the arrangement of a plurality of illumination sensors on one side of the imaging sensor.

FIG. 8e is an example showing the arrangement of a plurality of illumination sensors in a matrix form.

FIG. 9 shows an illumination sensor having a plurality of sensor elements is used to measure the spectral spectra of the illuminating source.

FIG. 10 summarizes the color management procedure, according to one embodiment of the present invention.

FIG. 11 is a schematic representation of a mobile phone having an imaging device and a color management device of the present invention.

### DETAILED DESCRIPTION OF THE INVENTION

It is known that white balance adjustment is a very difficult, multidimensional issue because of the various conditions regarding ambient light, the reflectance properties of the imaging objects, the design of color filters in the image sensor, the sensitivity of the sensor material to different wavelengths, the adaptation capability of the human eyes in the imaging situation and in the viewing situation, and the features of the image display device, for example. The present invention reduces the complexity in white balance adjustment by separating the affects of ambient light condition on the image data from the affects of display condition. The present invention is concerned with a color control system for estimating the white point as perceived by the human eyes at the time and place of image capturing.

At the time of image capturing, it is usually not possible to capture on the image sensor an area that can be used as a reference white area. The color at any part of the image sensor is likely affected by the reflectance of the photographed target or scene. That fact renders it difficult to carry out a meaningful or useful white balance adjustment. Furthermore, the spectral characteristics of the image reproduction or display device vary significantly from one type of the device to another and it would be difficult to predict, at the time of image capturing, what reproduction or display device will be used to reproduce the image.

In light of the various issues in image capturing and display, the color management method and system, according to the present invention, carries out the tasks of color space correction at two separate stages: one at the image capturing stage and one at the image display stage. Sometimes those separate stages can be merged together in order to reduce the computational load, if the image is displayed simultaneously within the image capture (e.g. viewfinder).

At the image capturing stage, the color management method and system, according to the present invention, is designed to recognize the ambient light condition, including the illuminating source or sources, and the time and place of image capturing. For example, the spectral distribution of natural light varies significantly with the time of the day. Thus, it is not sufficient to identify only the illuminating source, but also the changes to the spectral distribution of the source.

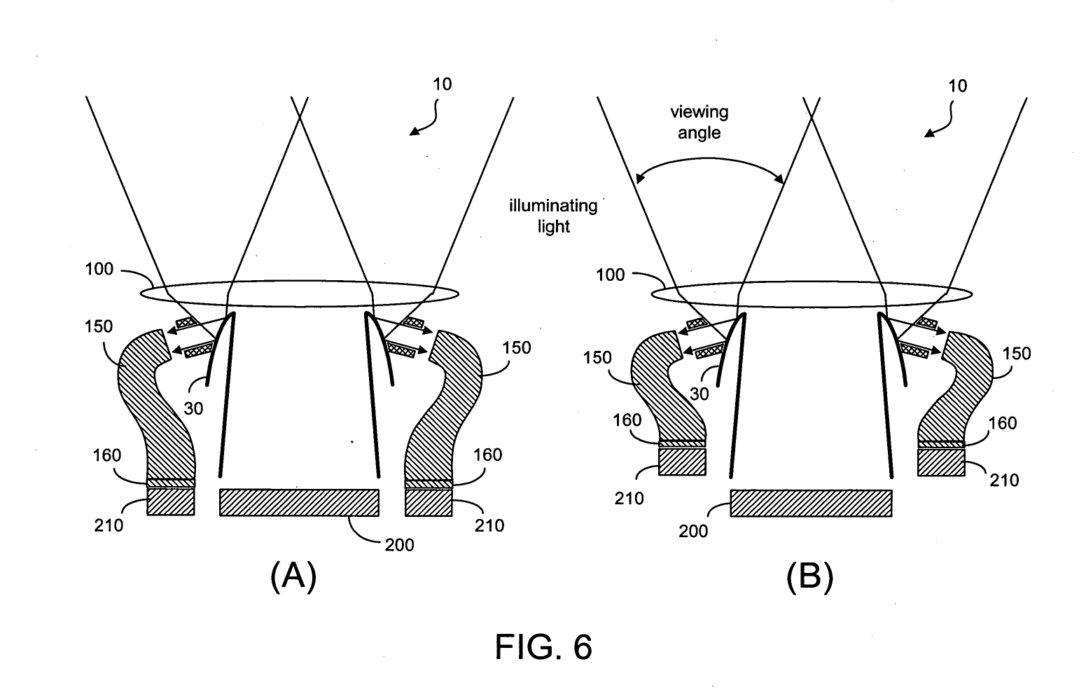

According to the various embodiments of the present invention, one or more illumination sensors are used to measure a wide range of wavelengths of the illuminating light. The illumination sensors can be implemented in an imaging device along with the image sensor, as shown in FIGS. 6a to 8b. The measured spectrum can include the IR and UV regions, for example, for the purposes of identifying the illuminating source or sources. Using narrow-band filters, a plurality of sensor elements are arranged to separately measure the illuminating light in the following spectral sub-bands or sections: 200-260 nm, 260-320 nm, 320-350 nm, 350-380 nm, 380-390 nm, 390-400 nm, . . . , 630-640 nm, 640-650 nm, 650-680 nm, 680-710 nm, 710-770 nm, 770-830 nm, and 830-890 nm, for example. Thus, the spectral distance in each of the wavelength sections within the wavelength range of 400 nm and 630 nm can be 10 nm, for example, but the spectral distance can be wider or narrower. Also, the entire measured spectral range can be wider or narrower than 200-890 nm. Based on the measured spectral data, an algorithm is used to identify the illumination source or sources. A plurality of sensor elements placed under a filter bank having a plurality of color filters r1, r2, . . . are shown in FIG. 9.

For illumination source identification purposes, it would be desirable to build a large database containing the spectral data of different illumination sources (natural light, candle light, fluorescent tubes of different color tones, camera flash, incandescent bulbs with or without halogen, light-emitting diodes, etc.) used at different locations (indoor, outdoor, in the desert, in a snow-covered area, near a beach, etc.) at different times of the day (including dawn and dusk). With the database, it is possible to design an algorithm to automatically identify the illuminating source or sources at the time of image capturing. Furthermore, the database contains a white point in each of a large variety of ambient light conditions. With such a “white point” database, an algorithm in an image data processing module can be used to adjust the color contents of raw image data in a certain color space once the illuminating source or sources have been identified. The adjustment on each of the colors in the color space can be carried out using information contained in a look-up table (LUT), for example.

Adjustment of the camera captured colors to the wanted color space includes different processing phases as auto white balance (AWB), color gamut modification and pixel response non-linearization. These operations may require offsets (scalar, vector), multiplications (scalar, vector), matrix operations, polynomial computation and LUTs (ID, 3D or ND). Using a 3D LUT as an example, the color adjustment involves at least a 3×3 matrix multiplication and 1×3 vector offset addition. In general, forming an original image from raw Bayer image data requires extensive color processing. For simplicity, the color processing operations are summarily referred to as LUT in this disclosure.

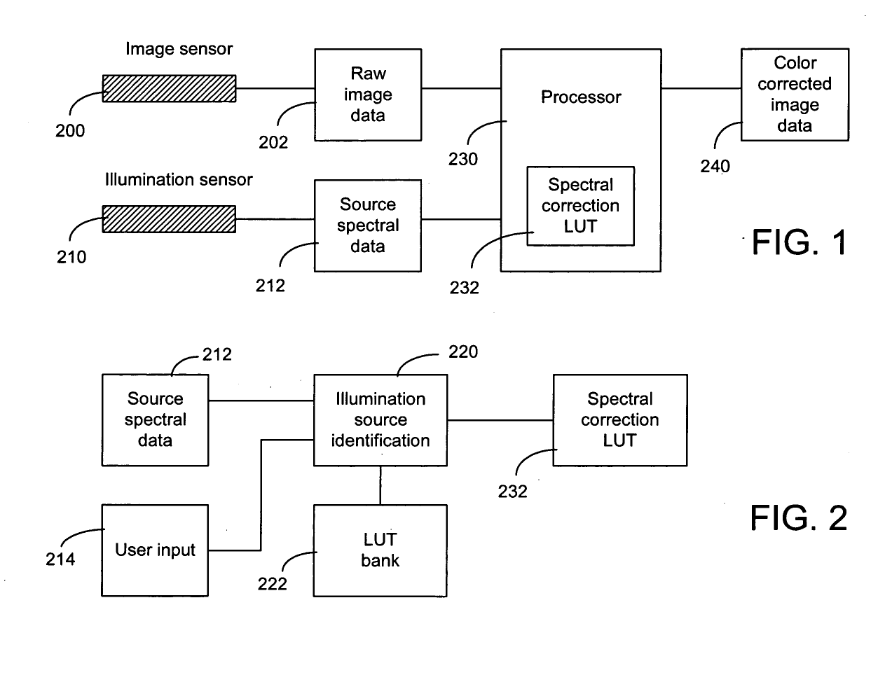

FIG. 1 summaries the process of color adjustment at the image capturing stage. As shown in FIG. 1, the source spectral data 212 from the illumination sensor or sensors 210 are conveyed to a processor module 230 along with the raw image data 202 from the image sensor 200 at the time of image capturing. After the illuminating source or sources are identified by the processor, a spectral correction LUT 232 is used to adjust the pixel value of the raw color image data in order to provide the color corrected image data 240. For example, if the illuminating source identification algorithm identifies candle light as the illuminating source based on the source spectral data, a “candle light” LUT is retrieved from an LUT bank for color correction purposes. If the image sensor is relatively less sensitive to the long wavelength regions than the human eyes to the same wavelength regions, then raw image data can be adjusted in order to enhance those particular regions. It is also possible to use the source spectral data to identify the lighting environments. For example, the illuminating source identification algorithm can be designed to identify a scene in a church, in an indoor concert, in an outdoor market, and so forth. In a similar fashion, when a mobile phone is equipped with the color adjustment process according to FIG. 1, it is possible to identify whether the phone is currently used in an indoor environment or in an outdoor environment. Based on the identification, a phone profile can also be changed.

Furthermore, it is possible to use a certain display device (a specially calibrated CRT, for example) to display images taken at different times of the day, at different locations and with different illuminating sources to compare the display images with the scenes as seen by the camera users. Based on the comparison, the LUT bank can be established or modified. Moreover, it is useful to implement a feature on the camera to allow the camera user to identify the image capturing condition. For example, the camera user can designate the captured image as an outdoor wedding picture or an indoor mass, for example. FIG. 2 summarizes the process of LUT selection. As shown in FIG. 2, as the source spectral data 212 is retrieved from the illumination sensor 210, an illuminating source identification algorithm 220 identifies the illuminating source or sources. Based on the identification, an LUT for the identified source or sources is retrieved from the LUT bank 222. The identification can also be aided by the user input 214.

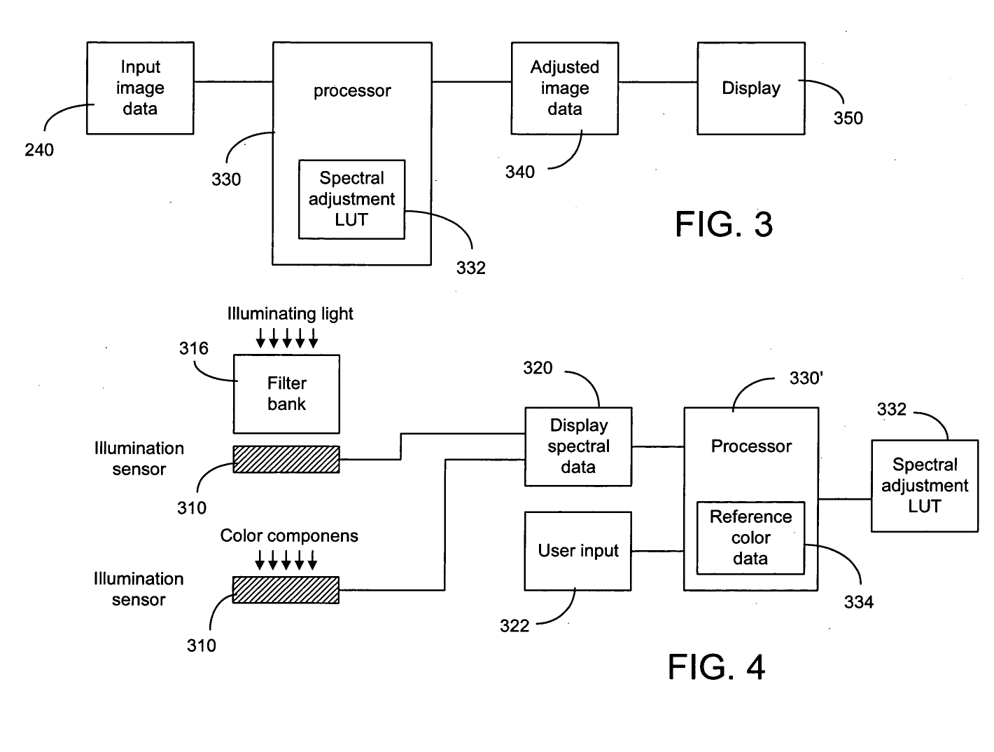

It should be noted that, the color adjustment on the raw image data, according to the present invention, is independent of the image visualization stage. In other words, the color adjustment is not carried out based on how the captured image is reproduced or on what type of display device the image is displayed. As such, it would not be necessary to establish a communication link between the image capture site and the image reconstruction site. As such, the computational requirements and the amount of transformations can be minimized, the quantization error can be reduced, and the color image quality can be improved. According to the present invention, the same set of color corrected image data can be displayed on any device and printed out by any printer. In order to adapt to different spectral characteristics of different display devices, the color management method and apparatus, according to the present invention, include an additional image data adjustment stage based on the used display device. FIG. 3 summaries the color adjustment in the image reconstruction or visualization stage. As shown in FIG. 3, before the input image data 240 is displayed on an image display device 350, the color contents of the image data may be corrected by an image data processor 330 based on a spectral adjustment LUT 332 depending on the spectral characteristics of the image display device. After such correction, the adjusted image data 340 is provided to the display 350 for display.

The spectral adjustment LUT can be generated based on the spectral components of the illuminating source as detected by an illumination sensor 310. For example, if a transmissive or transflective LCD display device is used to display the image and a back-light source is used for illumination, it is possible to divert a small part of the illuminating light to an illumination sensor for spectral analysis purposes. As shown in FIG. 4, a filter bank 316 can be used to separate the color components in the illuminating source so as to provide the spectral data 320 of the white point of the display. The relative intensities or values among the color components in the measured white point can be compared to the relative intensities in a reference white point 334 by a processor 330′ so that the input image data 240 can be adjusted based on the comparison. For example, the specially calibrated CRT that is used in the raw image data correction stage can be used to provide the ratio of the intensities among the color components in the reference white point. If the ratio of the intensities among the display color components is different from the reference ratio, then the color adjustment on the input image data can be based on the difference.

In an emissive display such as a plasma display device, the intensities of the color components of a “white” pixel can be separately produced and detected by an illumination sensor 310.

Furthermore, it is also possible to select a spectral adjustment LUT based on the user input 322 regarding the type of display.

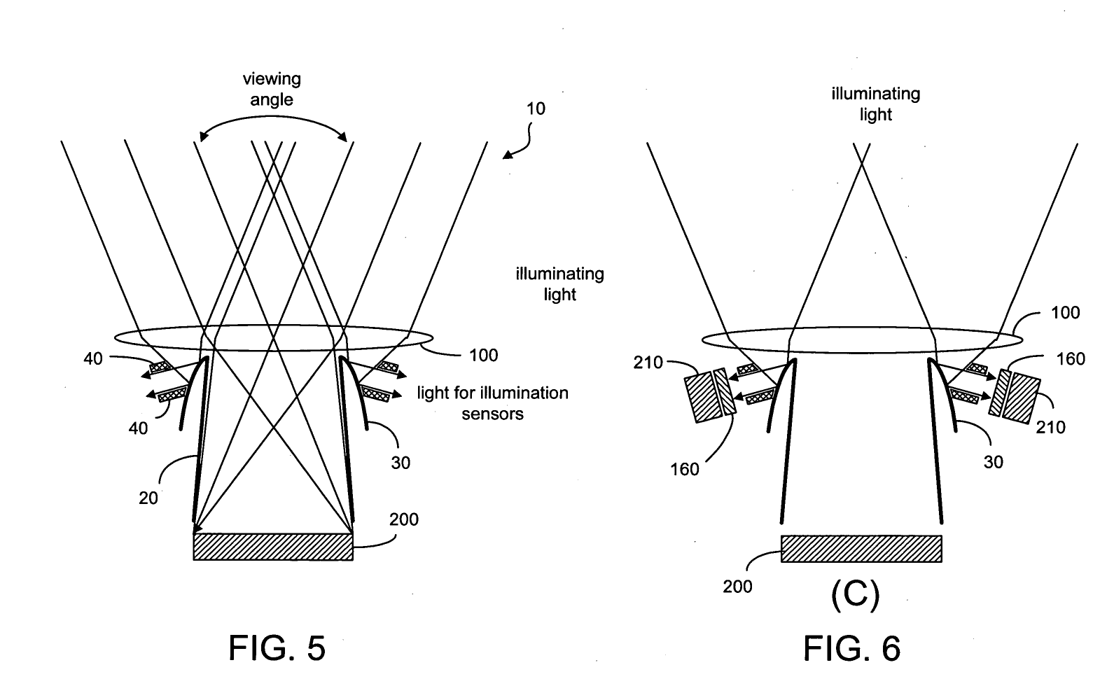

At the image capturing stage, the spectral distribution of an illuminating light source can be measured using an illumination sensor concurrently with the image capturing by an image sensor. For example, a large-aperture lens can be used for image capturing, and part of the light collected by the lens can be directed to the illumination sensor. As shown in FIG. 5, the imaging device 10 has a lens system 100 for forming an image on an image sensor 200. A light blocking structure 20 is used to define the image forming aperture of the lens and to block the sensing beam (the light beam for the illumination sensor) from reaching the image sensor 200. It is possible to use a reflector 30, such as a reflector with a convex surface, to alter the focal point and the optical path of the sensing beam and to enlarge its beam width. Another light blocking structure 40 is used to define the angle of the sensing beam so that the angle and direction of the sensing beam is substantially equal to the viewing angle of the image sensor. The sensing beam can be channeled to an illumination sensor 210 via a light conduit 150. The light conduit 150 may comprise a plurality of light pipes to direct the sensing beam to a plurality of sensors, for example. A light diffuser 160, such as a piece of white frosted glass or plastic is placed in the optical path of the sensing beam. Between the light diffuser 160 and the illumination sensor 210, a filter bank 180 having a plurality of narrow-band color filters is used to separate the illuminating light into a plurality of wavelength sub-bands, as shown in FIG. 9.

As shown in FIG. 6a, the illumination sensor 210 is located substantially on the image plane of the lens 100. Thus, it is possible to fabricate the illuminator sensor 210 and the image sensor 200 on the same semiconductor chip. It is also possible to use an illumination sensor 210 which is physically separate from the image sensor 200, as shown in FIG. 6b. It is also possible to direct the sensing beam directly to the illumination sensor 210 via a diffuser 160, as shown in FIG. 6c.

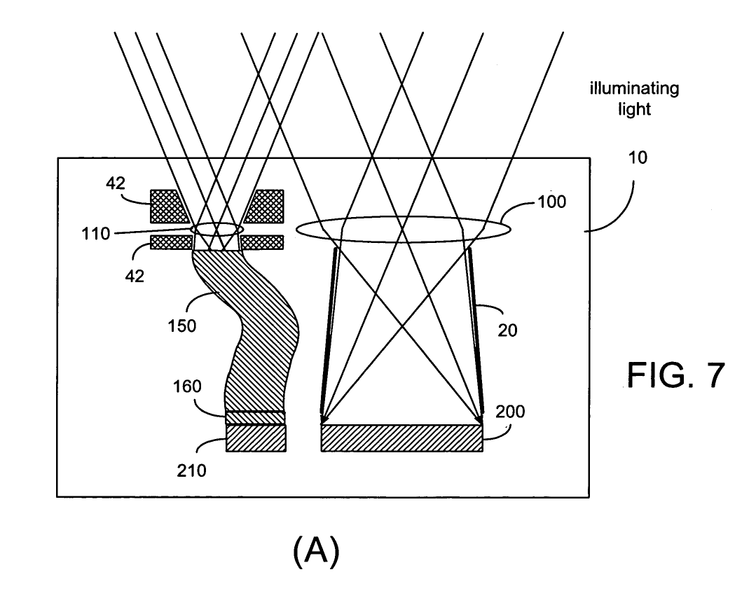

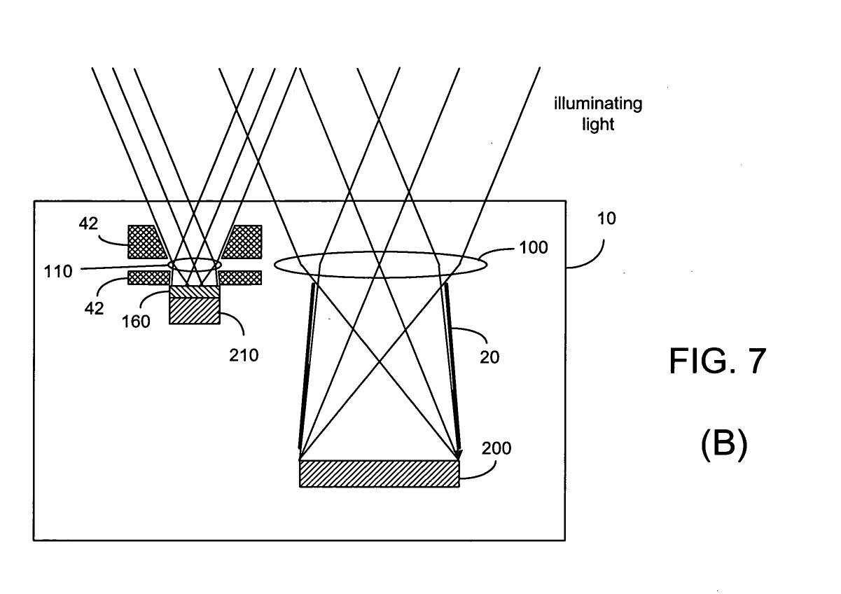

In a different embodiment of the present invention, the illumination sensor 210 has separate light collecting optics. As shown in FIG. 7a, a separate lens 110 is used to collect the sensing beam along with the image-forming beam. A light blocking structure 42 is used to define the angle of the sensing beam. The sensing beam is channeled to the illumination sensor 210 through a light conduit 150 and a diffuser 160. Alternatively, the illumination sensor 210 and the diffuser 160 are placed adjacent to the collecting lens 110.

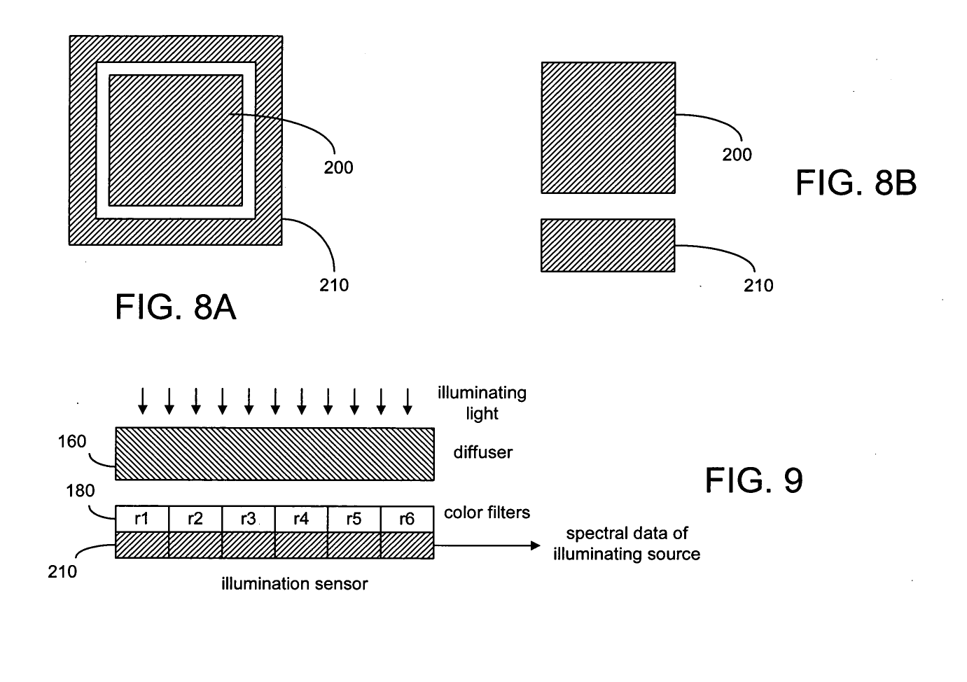

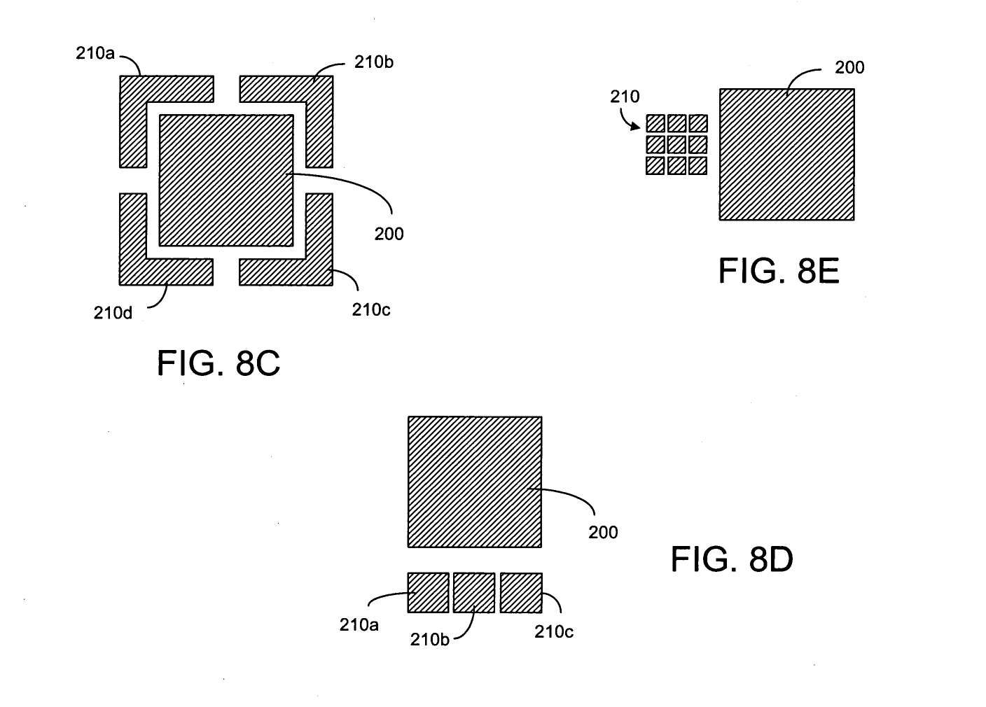

When the illumination sensor 210 and the image sensor 200 are fabricated on the same chip, it is possible to fabricate the illumination sensor 210 around the image sensor 200, as shown in FIG. 8a. It is also possible to fabricate the illumination sensor 210 as one or more segments on one or more sides of the image sensor 200, as shown in FIG. 8b. It is also possible to use directional detection of illumination sources by creating the illumination sensor so that different parts of the illumination sensor capture the light from different directions. For example, four separate illumination sensors 210a, 210b, 201c and 201d can be arranged around the image sensor, as shown in FIG. 8c. Each of the image sensors has its own narrow-band filters to separate the illuminating light into a plurality of wavelength sub-bands, as shown in FIG. 9. As such, illumination directions can be measured and it is possible to know that the upper corners are illuminated mainly by sunlight, and the other part of the image is illuminated mainly by halogen light, for example. A plurality of image sensors 210a, 210b and 210c can also be disposed on one side of the image sensor 210, as shown in FIG. 8d. The image sensors can also be arranged in an N×N matrix, as shown in FIG. 8e.

In sum, the present invention provides a color management system for adjusting the color contents of the image data of a digital image based at least on the source or sources of illuminating light at the time of picture taking. Thus, the color management system, according the present invention, includes a processor for adjusting the image data based on the source spectral data collected from the illumination sensor. The source or sources of the illuminating light can be recognized or identified by comparing the measured spectral distribution of the illuminating light and a source spectral data bank stored in an LUT module, as shown in FIGS. 1 and 2. This part of the color management system is associated with an imaging device. A different part of the color management system is associated with an image display device, as shown in FIGS. 3 and 4. Thus, the color management system further comprises a processor for further adjusting the color contents of the image data based on the color characteristics of the image display device. The color characteristics can be obtained from an illumination sensor which measures the spectral properties of the spectrally filtered illuminating light or the color components of the display.

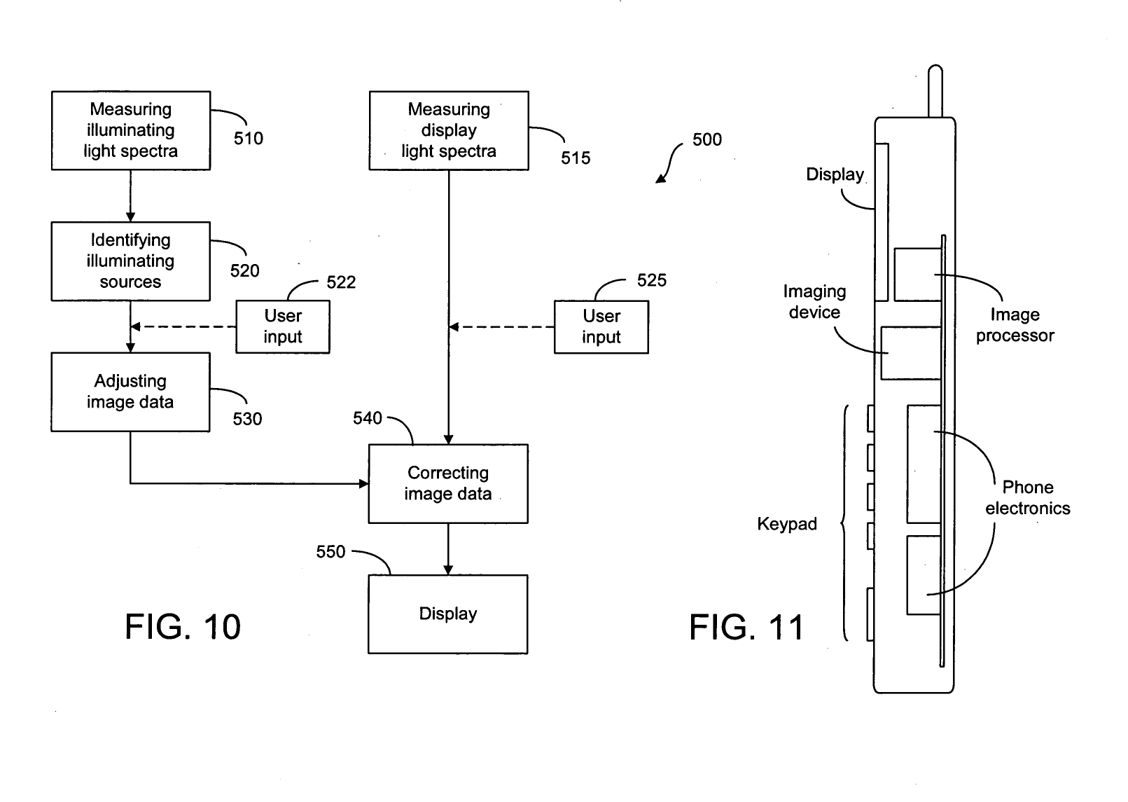

FIG. 10 summarizes the color management procedure 500. At step 510, the spectral distribution of the illuminating light is measured so that the illuminating source or sources can be identified at step 520. Based on the identification, the color contents of the image data are adjusted at step 530. It is possible to have a user interface on the imaging device so as to allow a user to identify the ambience at the time of picture taking at step 522. The adjusted image data can be stored for further use. For example, when the image data is used for display on a display device, it is possible to measure the color characteristics of the display device at step 515. The image data can be further corrected based on the color characteristics of the display device at step 540. The further corrected image data is then conveyed to the display device for display at step 550. It is possible to have a user interface at the display side to allow a user to identify the type of display at step 525.

It should be noted that the imaging device 10 of the present invention, can be a digital camera, but it can also be a part of an electronic device, such as a mobile phone, a personal digital assistant (PDA) device, a communicator device and the like. A mobile terminal having an imaging device and the color management module (included in the image processor module), according to the present invention, is shown in FIG. 11. Typically, the mobile terminal has a display, a keypad and various electronic components to process data including received data and data to be transmitted via a transceiver front-end. The color management system including the illumination sensor 210, the source spectral data bank 212, and the processor 230, as shown in FIG. 1, can be integrated into an imaging device. The color management system can be also disposed separately from the imaging device. In the latter case, the color management system may have a separate light collecting unit for directing part of the illuminating light to the illumination sensor. Furthermore, the illumination sensor 310, the reference color data bank 334 and the processor 330′ as shown in FIG. 4, can be integrated into an image display device. The color management system can be also disposed separately from the image display device.

Thus, although the present invention has been described with respect to one or more embodiments thereof, it will be understood by those skilled in the art that the foregoing and various other changes, omissions and deviations in the form and detail thereof may be made without departing from the scope of this invention.

What is claimed is:

1. A method, comprising:
measuring spectral distribution of illuminating light of a scene substantially at a time of taking a picture of the scene for providing measurement data indicative of the spectral distribution; and
identifying one or more sources of the illuminating light based on the measurement data.

2. The method of claim 1, wherein the picture comprises image data having color contents, said method further comprising:
adjusting the color contents in the image data based on the identified one or more sources.

3. The method of claim 2, further comprising:
establishing a white point for each of said one or more sources, wherein said adjusting is also based on the white point for said one or more sources.

4. The method of claim 1, wherein said picture is taken with an imaging device, said method further comprising:
providing at least one source sensor on the imaging device for carrying out said measuring.

5. The method of claim 4, wherein said imaging device comprises an image sensor for taking the picture at an image plane, and wherein the source sensor is provided substantially on the image plane.

6. The method of claim 4, wherein said imaging device comprises an image sensor for taking the picture at an image plane, and wherein the source sensor is provided in a location different from the image plane.

7. A color management system, comprising:
a color sensing module for measuring spectral distribution of illuminating light of a scene substantially at time of taking a picture of the scene for providing measurement data indicative of the spectral distribution; and
a processor, for identifying one or more sources of the illuminating light based on the measurement data.

8. The system of claim 7, wherein the color sensing module comprises
one or more sensors; and
a plurality of color filters disposed adjacent to said one or more sensors for measuring the spectral distribution.

9. The system of claim 8, wherein the color sensing module further comprises:
a light diffusing element in relationship to said one or more color filters; and
a light directing element for receiving part of the illuminating light and for directing at least some of the received part of the illuminating light to said one or more color filters through the light diffusing element.

10. The system of claim 8, wherein the color filters comprise narrow-band color filters for separating the received part of the illuminating light into spectral sub-bands.

11. The system of claim 10, wherein the sub-bands cover a spectral range substantially from 200 nm to 890 nm.

12. The system of claim 9, wherein the light directing element comprises one or more reflecting surfaces for reflecting the received part of the illuminating light toward said one or more color filters.

13. The system of claim 9, wherein the light directing element comprises one or more lenses for receiving part of the illuminating light.

14. The system of claim 7, wherein the picture comprises image data having color contents, and wherein the processor is also adapted for adjusting the color contents in the image data based on the identified one or more sources.

15. The system of claim 7, further comprising:
a source spectral data bank comprising spectral data of a plurality of illuminating sources so as to allow the processor to identify said one or more sources of the illuminating light also based on the source spectral data bank.

16. The system of claim 14, wherein the image data is adapted for display on an image display device having color characteristics, and wherein said adjusting is also based on the color characteristics of the image display device.

17. The system of claim 14, wherein the processor is adapted for providing adjusted image data based on the adjusted color contents, and wherein the adjusted image data is adapted for display on an image display device having color characteristics, said system further comprising:
a sensor element for measuring the color characteristics of image display device; and
an adjustment unit for further adjusting the adjusted image data according to the color characteristics of the image display device.

18. An imaging device, comprising:
an imaging sensor for picture taking under illuminating light;
a source sensor, adapted for measuring spectral distribution of the illuminating light substantially at a time of taking a picture for providing measurement data indicative of the spectral distribution; and
a processor, for identifying one or more sources of the illuminating light based on the measurement data.

19. The imaging device of claim 18, wherein the picture comprises image data having color contents and wherein the processor is adapted for adjusting the color contents based on the identified one or more sources and for providing adjusted image data based on the adjusted color contents.

20. The imaging device of claim 18, further comprising:
an optical unit for receiving part of the illuminating light and for focusing part of the received illuminating light on the imaging sensor for picture taking, and
a light directing element, disposed in relationship to the optical unit, for directing a portion of the received illuminating light to the source sensor.

21. The imaging device of claim 20, wherein the light directing element comprises one or more reflecting surfaces for directing the portion of the received illuminating light to the source sensor.

22. The imaging device of claim 21, further comprising:
a plurality of narrow-band color filters for separating the portion of the received illuminating light into spectral sub-bands.

23. The imaging device of claim 22, wherein the light directing element further comprises one or more light conduits for directing the portion of the received illuminating light from said one or more reflecting surfaces to the source sensor through the narrow-band color filters.

24. The imaging device of claim 22, further comprising:
one or more light diffusing elements disposed between the light direction element and the color filters.

25. The imaging device of claim 20, wherein the light directing element comprises one or more lenses for directing the portion of the received illuminating light to the source sensor.

26. The imaging device of claim 18, wherein the imaging sensor is disposed at an image plane, and the source sensor is disposed substantially in the image plane.

27. The imaging device of claim 18, wherein the imaging sensor is disposed at an image plane, and the source sensor is disposed in a location different from the image plane.

28. The imaging device of claim 18, wherein the imaging sensor is disposed at an image plane and the imaging sensor has a plurality of sides on the image plane, and wherein the source sensor comprises a plurality of sub-sensors disposed at one or more sides of the imaging sensor.

29. The imaging device of claim 18, further comprising:
a user interface for allowing a user to identify ambience at the time of picture taking.

30. The imaging device of claim 29, wherein the identified ambience includes the time of picture taking.

31. The imaging device of claim 29, wherein the identified ambience includes a place of picture taking.

32. The imaging device of claim 29, wherein the identified ambience includes said one or more sources.

33. A mobile terminal, comprising an image device of claim 19.

34. The mobile terminal of claim 33, further comprising an image display device, wherein the processor is also adapted to provide adjusted image data to the image display device for displaying, and wherein the processor is also adapted for further adjusting the adjusted image data based on color characteristics of the image display device.
